(19) United States
(12) Patent Application Publication
(10) Pub. No.: US 2004/0054448 A1
(43) Pub. Date: Mar. 18, 2004

(54) Automatic detecting system for events such as aircraft takeoff/landing

(76) Inventor: Hiroshi Ito, Tokyo (JP)

Correspondence Address: KAZUYUKI NIEDA, 14403 PEACH HILL RD., MOORPARK, CA, 93021, US

(21) Appl. No.: 10/466,996

(22) PCT Filed: Jun. 6, 2001
(86) PCT No.: PCT/JP01/04757

(30) Foreign Application Priority Data
Feb. 2, 2001 (JP) 2001-67777

(51) Int. Cl. G06F 19/00

(52) U.S. Cl. 701/14; 701/15; 701/16

(57) ABSTRACT

A system is directed at automatically detecting events that are extremely important for a civil airline, and which have conventionally been grasped by means of radio intercepts by experts in air traffic control, such as TAKEOFF, LANDING, GO-AROUND, DIVERT after entry into an approach area, REJECT-TAKEOFF, arrival at an arbitrarily set altitude, entry into HOLDING, and release from HOLDING of civil aircraft; for a data source, response waves from a conventional ATC mode S transponder are received when these are transmitted by aircraft for the purpose of receiving air control, and data comprised therein is extracted and used; a computer comprises a simplified initialization function, allowing detection conditions to be set simply by selecting related parameter values from a list for each event to be detected, so as to readily adapt to the specific operations of each airport and airline company.

### TECHNICAL FIELD

The present invention is separate from an air traffic control system used by an air traffic controller and is directed at automatically detecting events that are extremely important for a civil airline, such as the TAKEOFF, LANDING, GO-AROUND, DIVERT after entry into an approach area, REJECT-TAKEOFF, arrival at an arbitrarily set altitude, entry into HOLDING, and release from HOLDING of civil aircraft in the vicinity of an airport, and is designed to reduce the number of aeronautical radio intercept personnel assigned by airlines to airports to acquire these events and to enhance the accuracy of this work.

### BACKGROUND ART

An understanding of aircraft events is extremely important for airline companies for reporting to government organizations other than air controllers and for efficiently operating airport facilities. Conventionally, to grasp these events, specialists familiar with air traffic control have simultaneously intercepted a number of frequencies of specialized aeronautical communications conducted in English (generally, these have been the three frequencies of approach control, tower control, and ground control, to which, in some cases, have been added radar control and company radio, which are occasionally used) and have provided these as information to relevant posts. Thus, airline companies have trained large numbers of these specialists and assigned them so that the operating hours of airports can be covered at all times, and have spent large amounts of money securing these human resources. However, the fact of the matter is that people sometimes fail to hear what is being said, due to individual differences and inattentiveness, and this has become the cause of major problems. When consideration is given to the current situation in which aircraft have become more expensive and larger in size in recent years, and high efficiency is required as a matter of course, and to improving customer services, it is necessary to increase this accuracy even further.

### DISCLOSURE OF THE INVENTION

The present invention is such that radio waves from an existing ATC mode S transponder, originally intended for receiving air control, are received when these are transmitted by aircraft in response to approach control and other such interrogation waves (SSR), and data comprised therein are decoded and utilized. These data are primarily: an airline code, a flight number, a flight altitude of the aircraft, an aircraft HEADING, and an ATC code. This is a method and device for capturing this data to a computer comprising a simplified condition-setting function, allowing detection conditions to be set simply by selecting related parameter values from a list for each event to be detected so as to readily adapt to the specific operations of each airport and airline company, and for automatically and accurately calculating in realtime each event that applies to the conditions previously set in this computer.

### BRIEF DESCRIPTION OF THE DRAWINGS

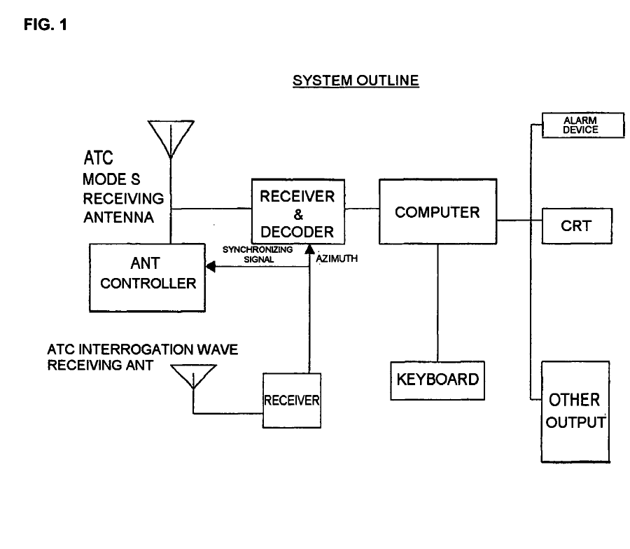

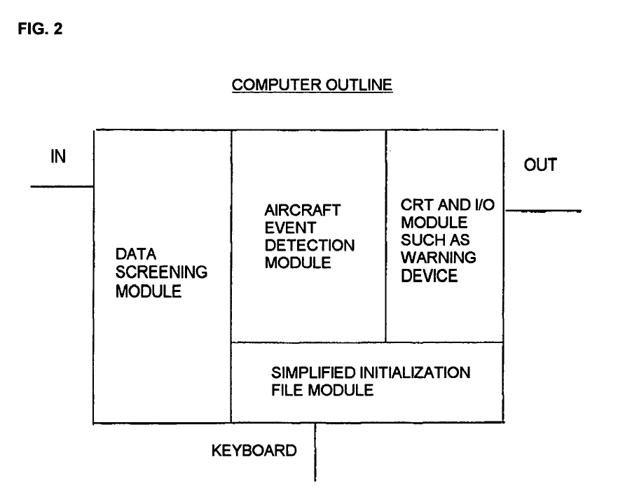

The overall constitution and connections of the system are as shown in FIG. 1 and the internal functional constitution of the computer is broadly divided into four components as shown in FIG. 2.

### BEST MODE FOR CARRYING OUT THE INVENTION

Describing the embodiment with reference to the figures, the constitution of the system is connected as shown in FIG. 1. An ATC mode S antenna and receiver, and decoder components thereof, are substantially the same as a receiver used in conventional air traffic control, with the exception of the fact that this does not transmit interrogation waves so as not to affect the air traffic control system. It accurately receives ATC mode S transponder radio waves emitted by an aircraft and extracts the data needed for computations from within these radio waves. It is constituted so as to be able to provide information as to what flight of which airlines is flying, at what altitude, and in which direction to a downstream computer as data. By further receiving interrogation waves (SSR) transmitted by approach control and the like, and using a receive-only parabola antenna synchronized to the detected rotation cycle thereof, it is possible to learn from the orientation of this antenna what bearing this aircraft is on, further enhancing reception sensitivity to a great extent. This bearing parameter is also provided to the downstream computer. The seven types of data indicated hereinbelow are acquired at this time. These are (1) an airline code of the aircraft; (2) a flight number of the aircraft; (3) a current altitude of the aircraft; (4) a HEADING of the aircraft; (5) an ATC transponder code currently selected by the aircraft; (6) a DESCREAT number of the aircraft; and (7) a bearing that the aircraft is on. In terms of the functions of the computer components, there are primarily three: a data screening module, an event calculation parameter list, and a computation and detection component.

The data screening module serves to accurately screen the required data, and to extract and sort data, such as the pertinent airline code, the pertinent flight number, the ATC transponder code currently selected by the pertinent aircraft, the pertinent aircraft HEADING, the pertinent aircraft altitude, and the DISCRETE number of the aircraft.

A simplified initialization file module is primarily a list of event calculation parameters; it is a selection list that enables differences in methods of calculating events, due to differences in operations, to be set simply by freely selecting parameter values from this list, such as altitude, altitude change, the aircraft HEADING, the bearing of the aircraft, and the rate of change and times therefor, allowing fast, effective utilization by any airline, at any airport at which it is installed. The aircraft event calculating module serves to calculate events for the aircraft and to detect TAKEOFF, LANDING, GO-AROUND, DIVERT after entry into an approach area, REJECT-TAKEOFF, arrival at an arbitrarily set altitude, entry into HOLDING, and release from HOLDING. The following are the conditions for detecting these.

TAKEOFF: when an aircraft at an arbitrarily set altitude or less reaches an arbitrarily set altitude

LANDING: when an aircraft descending at a rate of descent of an arbitrarily set value or more reaches an altitude of an arbitrarily set value or less

GO AROUND: when an aircraft descending at a rate of descent of an arbitrarily set value or more begins climbing to an altitude of an arbitrarily set value or more and does not depart from an arbitrarily set hypothetical GO AROUND area

DIVERT: when an aircraft descending at a rate of descent of an arbitrarily set value or more climbs to an altitude of an arbitrarily set value or more and departs from an arbitrarily set hypothetical GO-AROUND area

REJECT-TAKEOFF: when a new entry aircraft stays at an arbitrarily set altitude or less without changing altitude, but changes its existing bearing by an arbitrarily set value or more after coming onto an arbitrarily set bearing and an arbitrarily set aircraft HEADING

Arrival at Arbitrarily Set Altitude: when an aircraft descending at a rate of descent of an arbitrarily set value or more reaches an arbitrarily set altitude, or when an aircraft of an arbitrarily set altitude or less reaches an arbitrarily set altitude

HOLDING: when the flight azimuth changes within an arbitrarily set altitude range without the aircraft departing, for an arbitrarily fixed time or more, from within a certain arbitrarily set area

Furthermore, the approach priority order is detected from the altitude of each flight.

A CRT and an I/O module, such as an alarm device, serve to interface with a system monitor; these components provide data in the required format to the required location.

Broadly speaking, there are four types of CRT screens. A simple initialization screen is a selection screen for user initialization; condition settings to be used for detection of each of the aircraft events to be detected, as described hereinabove, are set according to the characteristics of the airport used and the preferences of the airline company by selecting appropriate values from a list for each parameter associated with the events. An ordinary display screen is a screen ordinarily used for displaying the airline company aircraft events selected in the initialization. A supplemental screen is a screen for displaying all of the received data for all the aircraft received or for specified airline companies. A manual input screen is a screen for manual input for making override corrections when there are discrepancies in the airline codes and flight number data being received.

An alarm device is a component for providing a warning to system monitors when GO-AROUND, DIVERT after entry into an approach area, REJECT-TAKEOFF, entry into HOLDING, or other such events occur for a selected airline flight, or when there is an aircraft for which data is incomplete, making discrimination impossible. Another output is a port that provides request-based output to users of the Internet, SITA (Societe Internationale de Telecommunications Aeronautiques) users, and the like.

Industrial Applicability

Currently, almost all airline companies assign specialists familiar with air traffic control to all the bases they service so as to cover all operating hours and accurately report on the operating conditions of their own aircraft in the vicinity of airports to relevant posts both inside and outside the company. If this system is used, since the information that is automatically sent from the equipment onboard an aircraft undergoes automated computer processing, a significant reduction in labor can be achieved, and in addition, since this system can be installed at all airports, even at extremely congested airports like Haneda Airport, or in cases where approach traffic has heretofore been complicated by irregularities to the point where confusion could not be avoided, this information can be provided accurately and in an orderly manner at all times without relying on humans.

Further, this same work, which airline companies currently perform by assigning specialists to airports, could be shared by installing one of these systems in every airport.

I claim:

1. A method and a device for use by a civil airline company, separate from an air traffic control system used by an air traffic control facility, for automatically and accurately calculating in realtime the occurrence of events that are extremely important for a civil airline company, such as TAKEOFF, LANDING, GO-AROUND, DIVERT after entry into an approach area, REJECT-TAKEOFF, arrival at an arbitrarily set altitude, entry into HOLDING, and release from HOLDING in the vicinity of an airport, by intercepting the radio waves of an existing ATC mode S transponder when a company aircraft transmits the same in response to air controller interrogation waves (SSR), utilizing the data comprised therein, and systematically inputting this data to a computer comprising a simplified condition-setting function, which allows detection conditions to be set simply by selecting related parameter values from a list for each event to be detected, so as to facilitate adaptation to the specific operations of each airport and airline company.
